(19) United States
(12) Patent Application Publication
(10) Pub. No.: US 2010/0243820 A1
(43) Pub. Date: Sep. 30, 2010

(54) TAKING OFF AND LANDING AIRPLANE USING VARIABLE ROTARY WINGS

(76) Inventor: Chaeho Lim, Hamyang-gun (KR)

Correspondence Address: SCHMEISER, OLSEN & WATTS, 22 CENTURY HILL DRIVE, SUITE 302, LATHAM, NY, 12110, US

(21) Appl. No.: 12/744,060

(22) PCT Filed: Nov. 8, 2008
(86) PCT No.: PCT/KR08/06569

§ 371 Date: May 21, 2010

(30) Foreign Application Priority Data
Nov. 26, 2007 (KR) 10-2007-0120694

(51) Int. Cl. B64C 27/24

(52) U.S. Cl. 244/7 A

(57) ABSTRACT

This invention is regarding a VTOL aircraft that is designed to enable it to take off by generating lift through rotary wings like a helicopter and then moving forward; and when it flies at high speeds, it is able to use jet engines so that it can generate lift through fixed wings while the rotary wings are transformed into fixed wings to generate lift by adjusting the angles between the individual wings thereby enhancing the efficiency

### TECHNICAL FIELD

This invention is regarding a VTOL aircraft using variable rotary wings that would take off vertically by generating lift using the rotary wings; fly forward at high speeds with the thrust generated using jet engines while adjusting the angles between each of the rotary wings to make them into a form of fixed wings that can efficiently generate lift

### BACKGROUND ART

Not only in Korea, where a great deal of the area is composed of mountains which poses a lot of trouble in constructing airfields, but also many other countries have insufficient numbers of airfields and the existing airfields are located far away from residential areas due to the great amounts of noise generated by airplanes, so not only have there been a lot of difficulties for small-to-medium sized groups or individuals in attempting to depart from places in the vicinity of their houses or work places and directly move to the desired destinations using airplanes without wasting precious time and energy; or for people in attempting to go into dangerous areas; or for military corps in attempting to move fast to locations for operations and vertically take off or land in order to execute operations, but also there have been a lot of problems involving accidents and the loss of human lives created by the existing VTOL airplanes due to their lack of safety caused by the unstability of the air current created when their rotary wings have been turned 90° anteriorly. Also, since the maximum speed of a normal VTOL is limited to 500˜600 km/h under current technologies. Flight speed is very important to people who need to reach their destination quickly, such as businessmen with deadlines or people who are exhausted by long flights, but many difficulties and problems occur when attempting to obtain higher speeds.

### DISCLOSURE OF INVENTION

### Technical Problem

The purpose of this invention is to enable a VTOL aircraft to safely change the form of its rotary wings while flying at high speeds in order to eliminate the danger that occurs when they attempt to transform from a VTOL aircraft into a fixed propeller wing-type aircraft for flying by turning their rotary wings 90° anteriorly due to the danger caused by the instability of the air current generated around the propellers or to relieve the inconvenience of them being unavoidably slower than aircraft that use jet engines since their maximum speed is limited to 500˜600 km/h under current technologies, since the variable rotary wings of the VTOL craft are located on the lateral sides of the main wings, VTOL crafts tend to be structurally weak at larger sizes, and the purpose of this invention is to solve this problem.

### Technical Solution

In order to achieve the above mentioned purpose, this invention is comprised of rotary wings with built-in drive motors that enable the body of the wings and the flying body of the VTOL aircraft to generate lift when vertically taking-off/landing and to efficiently generate lift when flying at high speeds by transforming the aircraft into a fixed propeller-type aircraft; in addition to the installation of a jet engine that will generate thrust when flying at high speeds. In this invention, the variable rotary wings are located at the top front side and the rear of the flying body.

### Advantageous Effects

As mentioned above, the VTOL aircraft with variable rotary wings made according to this invention will be able to generate lift in the form of rotary winged aircraft in order to vertically take off even from roads, buildings, parking lots, ship decks, etc, and move forward like a helicopter; and, when necessary, it will be able to safely and efficiently fly at high speeds by generating thrust with jet engines while shifting the rotary wings into fixed wings by adjusting the distance between the wings while controling the built-in driving gears; and since the variable rotary wings are located on the top front side and the rear of the flying body, the aircraft can be larger and still maintain structural integrity.

### BRIEF DESCRIPTION OF DRAWINGS

FIG. 1 is a diagonal view of a VTOL airplane with variable rotary wings as it takes off vertically,

FIG. 2 is a diagonal view of a VTOL airplane using variable rotary wings without tail wings when it is vertically taking off,

FIG. 3 is an illustration of the a diagonal view of the variable rotary wings with its major parts cut off,

FIG. 4 is a diagonal view of the adjusted variable rotary wings,

FIG. 5 is a diagonal view of a VTOL airplane while its variable rotary wings have been made into the state of fixed wings by adjusting the angles between each of the wings,

FIG. 6 is a diagonal view of a VTOL airplane without tail wings while its variable rotary wings have been made into the state of fixed wings by adjusting the angles between each of the wings,

FIG. 7 is a diagonal view of the VTOL airplane with variable rotary wings when vertically taking off,

FIG. 8 is a diagonal view of a VTOL airplane using the variable rotary wings without tail wings when it is taking off vertically,

FIG. 9 is an illustration of the a diagonal view of the variable rotary wings with its major parts cut off,

FIG. 10 is a diagonal view of the adjusted variable rotary wings,

FIG. 11 is a diagonal view of a VTOL airplane while its variable rotary wings have been made into the state of fixed wings by adjusting the angles between each of the wings,

FIG. 12 is a diagonal view of a VTOL airplane without tail wings while its variable rotary wings have been made into the state of fixed wings by adjusting the angles between each of the wings,

FIG. 13 is a diagonal view of a VTOL airplane using the variable rotary wings to land vertically.

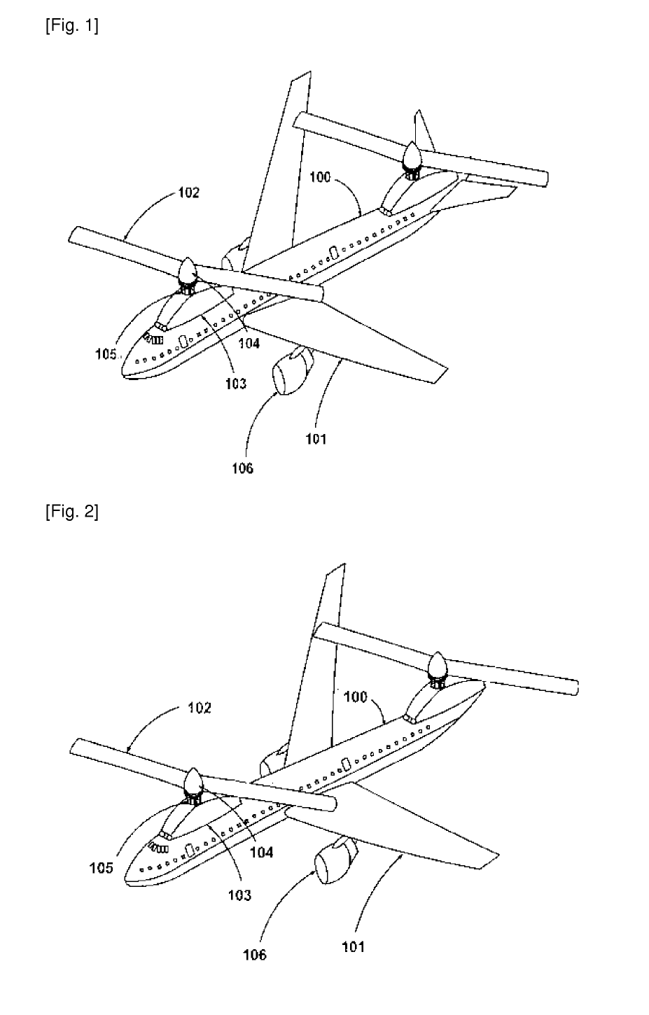

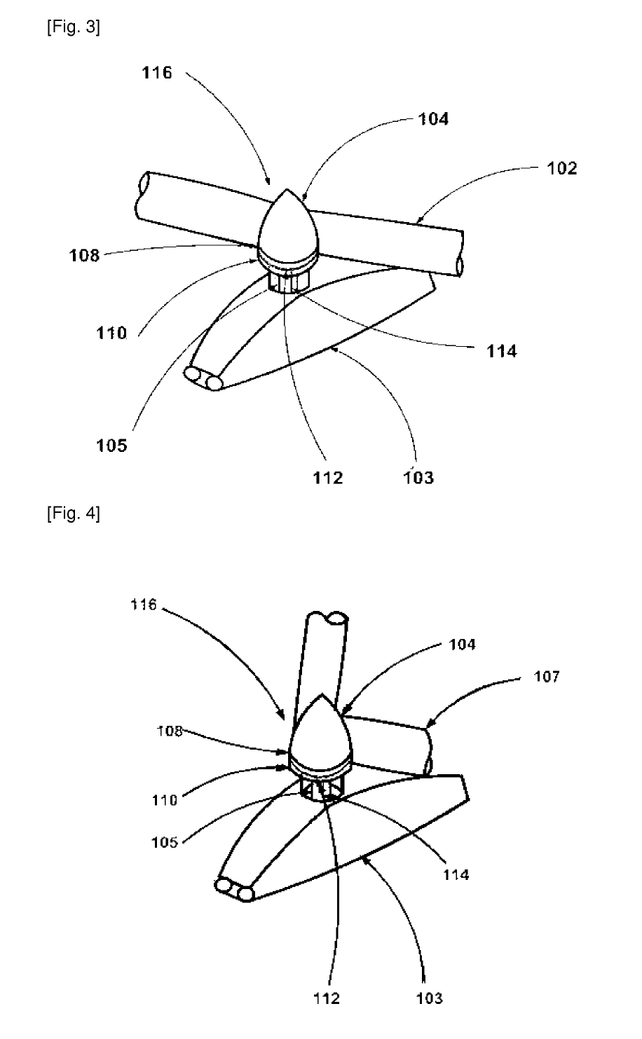

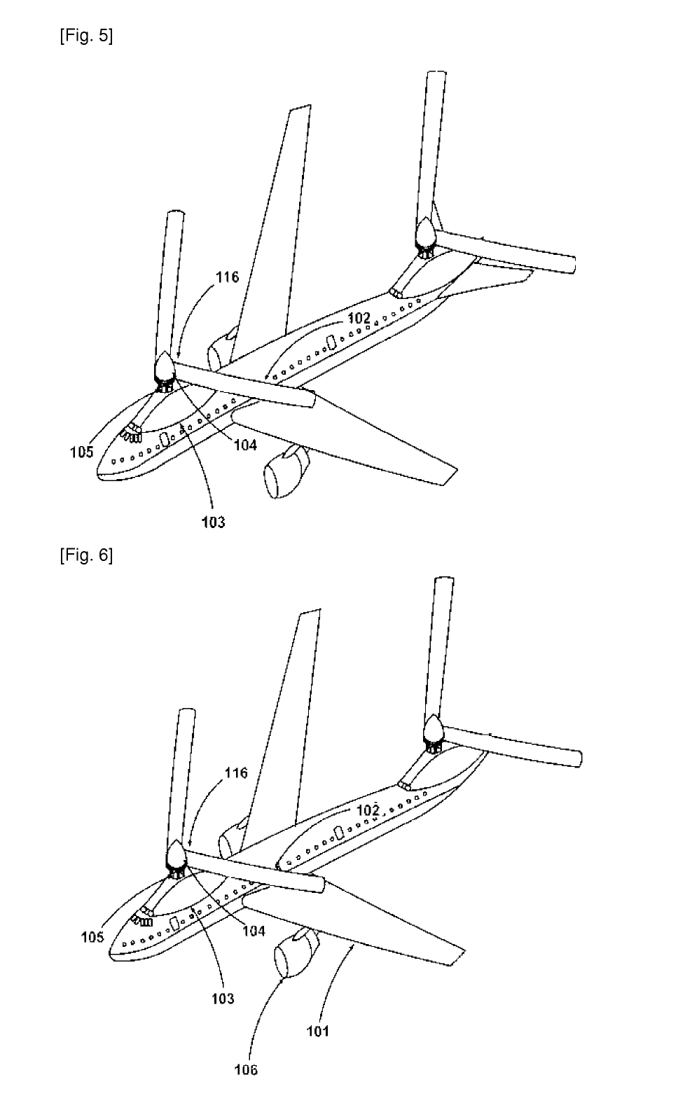

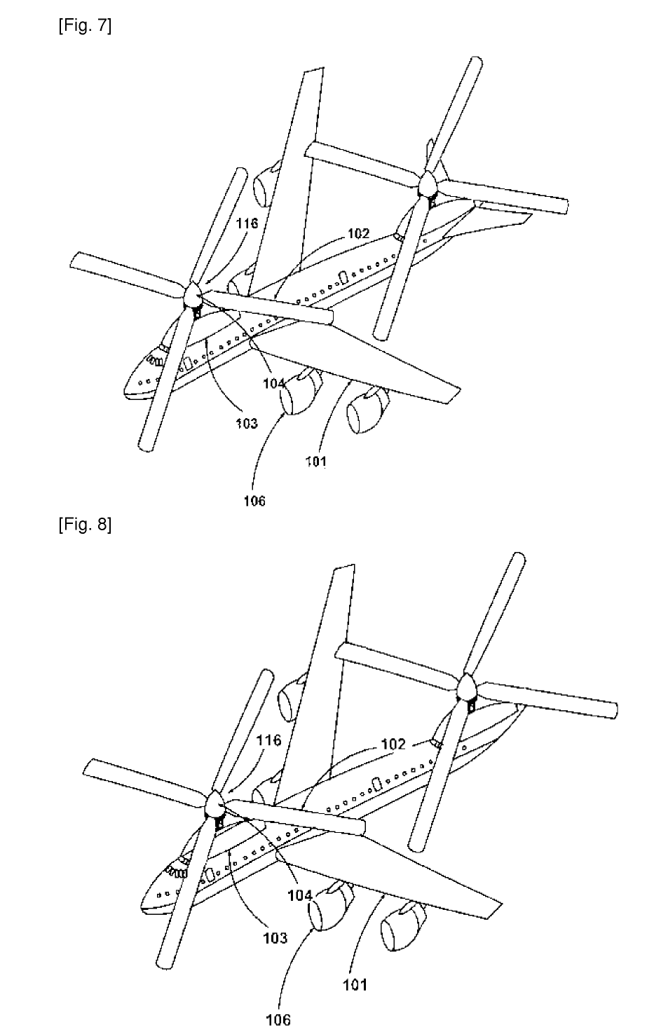

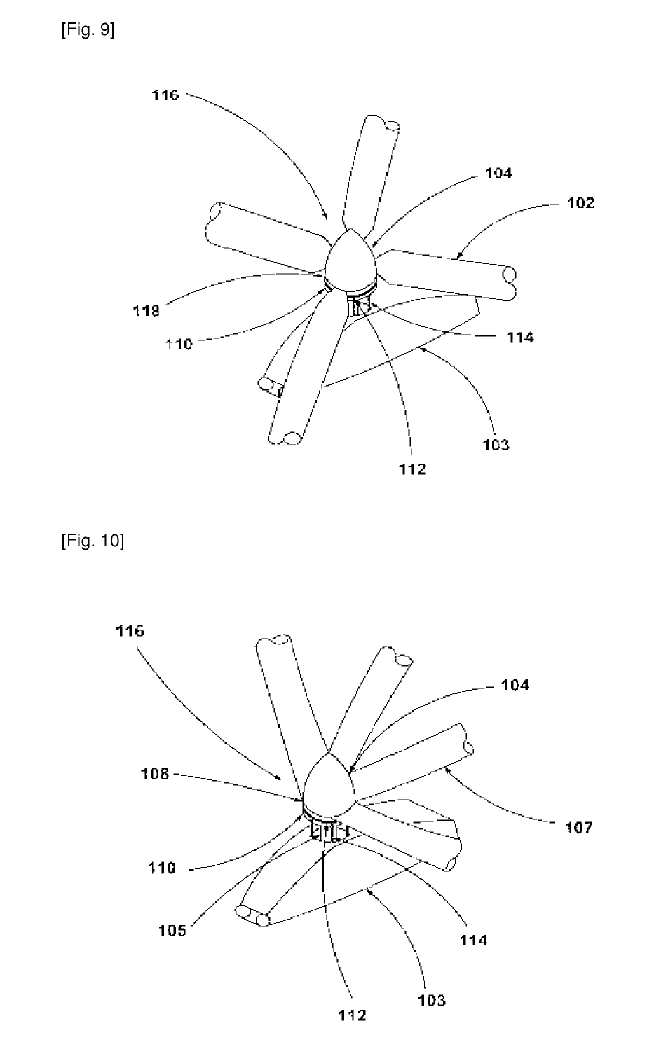

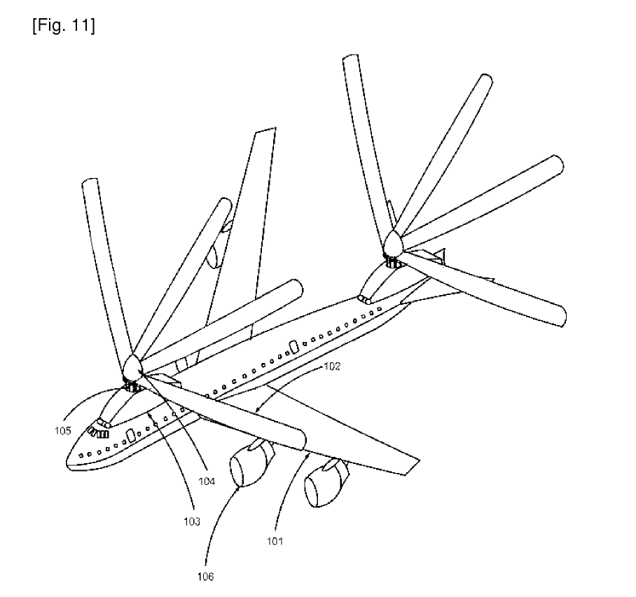

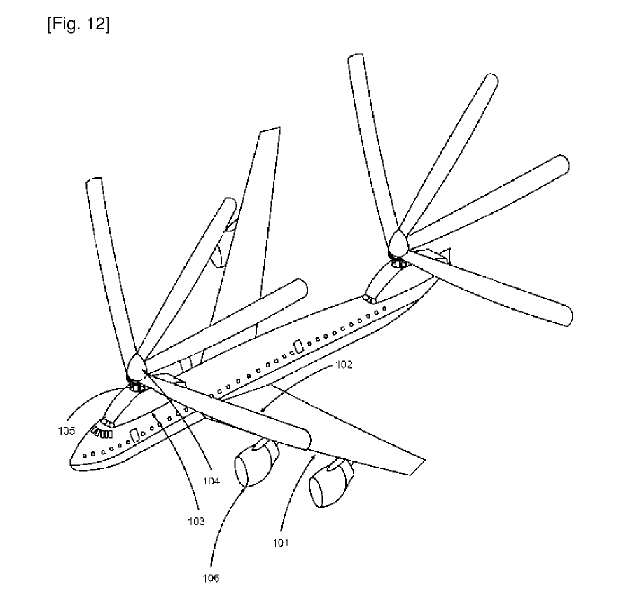

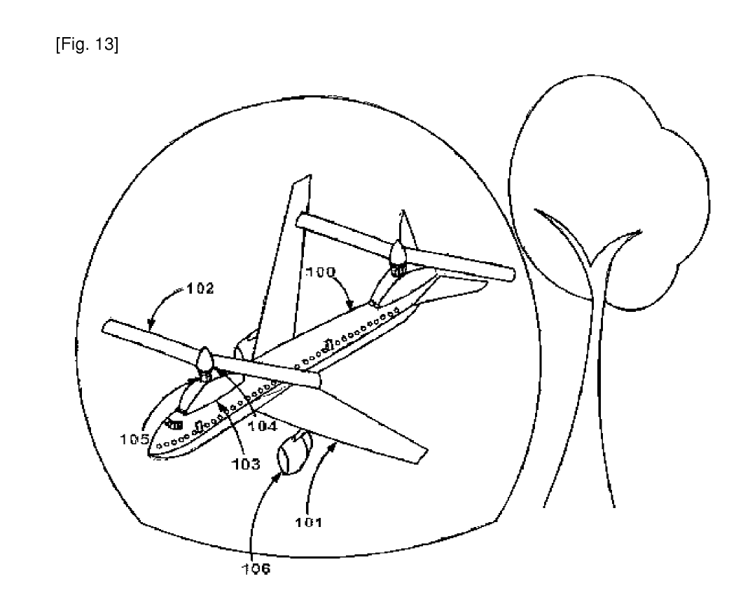

### BEST MODE FOR CARRYING OUT THE INVENTION

As illustrated in the figures, the entire composition of this invention is comprised of a flying body (100), the flying wings (101) mounted unmovably on the sides of the body (100), the rotary wings (102) which are rotated by the rotary wing engines (103) mounted on the sides of the above mentioned flying wings (101) and the rotary wing angle adjusting means (104) mounted on the center of the rotary wings (102).

Above mentioned variable rotary wings (116) which is comprised of the propeller angle adjusting means (104), rotary wings (102) which are fixed on the propeller angle adjusting means (104), the propeller angle adjusting means (104) which is fixed on the upper swash plate (108) to enable the upper swash plate (108) to turn toward the angle of inclination of the lower swash plate (110), which is connected to the lower plate (110) by ball bearings to enable rotation in every direction, including up and down, the lower plate (110) which connects the load to the hinge to enable control by the controllers from the operating seat

The VTOL (100) rotates the rotary wings (102) to generate lift when taking-off; and when going forward, the lower swash plate (110) is tilted toward the front of the VTOL (100) by the hinge type rod (114) connected to the control device in the operating seat making the upper swash plate (108) connected with the lower swash plate (110) through the ball bearing (112) rotate in the tilted state and making the rotary wing angle adjusting means (104) mounted on the upper swash plate (108) rotate together in the tilted state and consequently the angle of attack of the wing mounted on the upper swash plate (108) is changed to produce thrust making the aircraft fly forward.

When it is necessary to fly at high speeds, the speed can be accelerated by operating the jet engines (106) and of each of the rotary wings (102) are turned using the rotary wing angle adjusting means (104) and transformed into fixed wings (107) while being adjusted to generate the optimum lift in order to enable the aircraft to fly at high speeds.

The aircraft has been designed to decrease drag and increase lift when adjusting angles between each of the rotary wings (102) using the driving shaft located inside of the rotary wing angle adjusting means (104) by adjusting the retreating angle to the direction opposite to the direction of the flying like eagles retreat their wings backward when flying fast so that the drag and lift of each of the two wings can be balanced between each other while flying and inside the driving shaft are the receiver and controller that receive signals from the operating seat for control and inside the driving shaft is also mounted onto the servo motor controlled by the receiver and controller to produce rotating motive power in order to drive the pinions mounted at the top end, and then the pinions, which are fixed to the gear driving shafts by pins, are engaged with the gears to convey the motive power and the gears are connected to the rotary wings (102) through the vertically moving shafts which are fixed to the rotary wings (102) by pins (P2) so that they can adjust the distances between individual wings and using this structure, the rotary wings (102) are turned to make the angles of retreating wings become close to 0° when the speed is below the critical Mach so that the lifts of the wings on both sides are balanced while flying and when the speed is to go over the critical Mach, the angles of retreating wings are adjusted toward the direction opposite to the direction of flying like eagles retreating their wings backward when flying fast to prevent a rapid increase of the entire drag due to the increased wave-making drag created by the impact waves occurring when the speed reaches at Mach 1 while controlling the wings to generate the optimum lift and transforming them into a form of fixed wings (107) to enable flying at high speeds; and the aircraft has been also designed to accelerate the speed while flying at high speeds by operating the Wing-Mounted Pad jet engines (106) that are mounted beneath the main wings to reduce the amount of noise delivered to the operating seat or riders' seats and to enable easy maintenance.

### Mode for the Invention

When high-speed flight is desired, the location of jet engines on the nose has advantages in that clean airflow is provided without being affected by the body, but has disadvantages in that the intake vent located on the nose requires a very long internal duct that causes frictional losses, increases the weight, and takes up a great portion of the body space. The location of the jet engines on the chin has advantages in that the length of the internal duct can be shorter compared to the location on the nose and air inhalation can be smooth with the high receiving angle but it poses a problem in securing the location to install the Nose Landing Gear. Generally, the nose landing gear is installed right after the intake vent to hold the nose landing gear in the cowl of the intake vent. The side-mounted intake vents commonly found in dual-engine airplanes provide short duct lengths and relatively clean air flows but the problem of the swirling air flows separated from the fore-body flowing into the duct at a high receiving angle should be solved. The problem of swirling air flows flowing into the duct as such is especially serious when the fore-body is square. Some single-engine airplanes also use side-mounted intake vents, and in such cases, there should be two separated ducts laid up to the front of the engines to avoid the problem of pressure instability. The armpit intake vents installed at the locations where the body and the high wings are joined together can make the length of the internal ducts very short but there is a very high risk that the intake vents will sink into the thick boundary layer formed in the interface between the fore-body and the wings and it must be recognized that the flows will be greatly distorted at the high receiving angle and the side sliding angle. Over-fuselage intake vents are in the form opposite to that of chin intake vents and they have the advantage that they have very short duct lengths without the problem of the nose landing gear installation but have the disadvantage that their air inhaling performances are deteriorated at high receiving angles. Those intake vents located on the tail wings may produce the effect to separate the flow of the body and to reduce drag but they require special forms of ducts and they are subject to the potential that the boundary layer may flow into them. Those intake vents installed in the front side of wings do not require separate cowls thus the wetted area of the entire airplane may be reduced but they have the disadvantage that they will changes the flows passing the wings and will increase the weight of wings. Over-wing pad engines can reduce the height of landing gear and reduce noise on the ground but they have the disadvantage that they make service difficult.

1. VTOL aircraft that flies with variable rotary wings (116) fixed on the front and rear side of the flying body (100) that generate lift while the vertically taking-off and landing aircraft are taking off; and the propeller angle adjusting means (104) that transform the rotary wings (102) of the variable rotary wings (116) into a form of fixed wings (107) when the aircraft are flying at high speeds; and the jet engines (106) that generate thrust so that the rotary wings (102) that have been transformed into a form of fixed wings (107) by the propeller angle adjusting means (104) can efficiently generate lift together with the flying wings (101) while the aircraft are going forward.

2. As mentioned in claim 1,
the VTOL aircraft that uses the above mentioned variable rotary wings (116) that flies with a flying body (100) where tail wings have been attached for stable flying and efficient generation of lift.

3. As mentioned in claim 1,
the VTOL aircraft that flies using the above mentioned variable rotary wings that have been fixed to the flying body (100) without any tail wing so that there would be no obstacle in efficiently generating lift using the above mentioned variable rotary wings (116).
